(19) United States
(12) Patent Application Publication
(10) Pub. No.: US 2015/0301704 A1
(43) Pub. Date: Oct. 22, 2015

(54) METHOD FOR PROVIDING PLAYBACK ORDER OF EBOOK AND ADD-ON

(71) Applicants: Seung Hwan Ji, (US); Jung Jin KOOK, Seoul (KR)

(72) Inventor: Jung Jin Kook, Seoul (KR)

(21) Appl. No.: 14/434,097

(22) PCT Filed: Oct. 8, 2013
(86) PCT No.: PCT/KR2013/009003

§ 371 Date: Apr. 7, 2015

(30) Foreign Application Priority Data
Oct. 8, 2012 (KR) 10-2012-0111235

(51) Int. Cl. G06F 3/0483; G06F 3/0484; G09B 5/06

(52) U.S. Cl. CPC G06F 3/0483; G09B 5/06; G06F 3/04842

(57) ABSTRACT

Provided is a method of providing the play order and add-on of e-book. The method of providing a play order and add-on of an e-book, which is executed in a viewer for playing an e-book that is a digital work described according to a certain order, include: playing an e-book in accordance with a provided play order information regardless of the order of the e-book itself as the viewer is provided with the play order information.

### TECHNICAL FIELD

The following disclosure relates to e-book and e-learning technical fields.

### BACKGROUND ART

Learning through a classic type of offline lecture is expected to be gradually replaced with an online type.

E-learning technology enables learners to simply learn through a computer without limitation of time and space, and in recent years, is substituting for a considerable portion of offline lecture.

Typical e-learning is usually based on the Web. That is, it is general that a user studies in a form similar to taking a class in a lecture room by connecting to a web site through a web browser and playing a lecture video of a lecturer.

However, it is expected in future that learning using e-book or other electronic types of books will be performed in various levels of schools and educational institutes. This type of learning is expected to show slightly different characteristics from web-based e-learning.

First, unlike existing e-learning, e-book itself has a possibility of being used as a medium of direct teaching behaviors with a lecturer.

In other words, lecturers selects teaching materials to lecture, and students take classes of lecturers offline or take classes while watching in a form of video. In this case, through an e-book or e-book terminal, tasks are set, and supplementary materials are provided. Also, instruction activities such as correction or instruction are performed through the e-book or e-book terminal.

Meanwhile, in case of classic types of lectures, lecturers (teachers and professors) who are giving lectures in schools or institutes select one book, and then add and use supplementary materials for every topic or part in their lecture or also deliver a lecture while varying the orders of book and lecture.

However, unlike e-learning provided with learning contents, since the e-book is distributed as a single complete work, it is difficult to change the contents of the work, and it is difficult for a lecturer to add supplementary materials according to his/her taste or adjust the learning order.

### DISCLOSURE

### Technical Problem

Accordingly, the present disclosure provides a method of interworking auxiliary materials or learning tools at a specific location of an e-book which is distributed as a complete work.

The present disclosure also provides a method of changing the play order of a unit content of an e-book and the display order of auxiliary materials and learning tools and distributing the changed play order.

### Technical Solution

In one general aspect, a method of providing a play order and add-on of an e-book, which is executed in a viewer for playing an e-book that is a digital work described according to a certain order, includes: playing an e-book in accordance with a provided play order information regardless of the order of the e-book itself as the viewer is provided with the play order information.

The method may further include activating the add-on when a certain condition is satisfied during the play of the e-book, as the viewer is provided with the add-on to be added to the e-book.

The play order information of the e-book may include a plurality of play orders re-defining a portion of unit contents of the e-book, and in the playing of the e-book, the viewer may sequentially display the plurality of play orders on one side thereof, and as one of play orders is selected by a user, may play the portion of the unit contents of the e-book in accordance with the selected play order.

The add-on may be an external learning tool that collects information from the e-book or when the e-book is played by the viewer, and transmits/receives certain information to/from a server through a network. The play order information may describe the play order of the unit contents of the e-book and location information on the e-book, where the external learning tool is to be activated. In the playing of the e-book, the viewer may activate the external learning tool when the activation order of the external learning tool arrives during the play of the unit contents of the e-book according to the play order information.

The external learning tool may provides: a communication measure for communication between a user of the viewer and users of other viewers; a measure for collecting an understanding degree of a user of the viewer with respect to the e-book; a measure for enabling an exchange of certain data between a user of the viewer and users of other viewers; or a measure for enabling a user of the viewer to perform learning through interaction.

The add-on may be an auxiliary material that is contents to be added to a certain location of the e-book. The play order information of the e-book may describe the play order of the unit contents of the e-book and the auxiliary materials. In the playing of the e-book, the viewer may sequentially play the unit contents of the e-book and the auxiliary materials in accordance with the play order information when the e-book is played.

When the auxiliary material is a video, in the playing of the e-book, the viewer may play and display the video on one side of the unit contents of the e-book when the play order of the auxiliary material arrives in accordance with the play order information during the play of the e-book.

The method may further include connecting, by the viewer, to a server and receiving data corresponding to a lecture to which a user is listening, as add-on and play order information corresponding to an identification information of the e-book using identification information of an already-loaded e-book and user information of the viewer.

In another general aspect, a method of providing a play order and add-on of an e-book, which is executed in a viewer for playing an e-book that is a digital work described according to a certain order, includes: loading, by the viewer, two or more e-books; connecting, by the viewer, to a server and receiving play order information corresponding to a combination of identification information of the two or more e-books using identification information of the two or more e-books that are already loaded; and playing, by the viewer, unit contents pertaining to the two or more e-books according to an order described in the play order information, wherein in the playing of the unit contents, when unit contents after a play of unit contents pertaining to one e-book are unit contents pertaining to another e-book, the viewer does not finish the play of the one e-book, and displays the unit contents of the other e-book in succession to unit contents that are finally played.

Other features and aspects will be apparent from the following detailed description, the drawings, and the claims.

### Advantageous Effects

According to an embodiment of the present invention, when a user takes an online/offline lecture using an e-book, a lecturer can freely add auxiliary materials to the e-book, and furthermore, can synchronize the play order of the e-book and the play order of the auxiliary materials with the lecture order of a lecturer. In addition, during the play of an e-book, a task can be set and evaluated, or the learning situation of students can be tracked. Particularly, the play order of two or more e-books can be integratedly controlled. Integrated learning using two or more e-books can be performed by organically combining and linking auxiliary materials and learning tools with two or more e-books.

### DESCRIPTION OF DRAWINGS

FIG. 1 is a view illustrating a relationship of a viewer, viewers of other users and a server.

FIG. 2 is a view illustrating the play order of contents of an e-book reconfigured in real-time in accordance with the play order selected by a user.

FIG. 3 is a view illustrating an auxiliary material related to contents of an e-book, being further displayed during the display of the contents of the e-book.

FIG. 4 is a view illustrating a learning tool activated during the display of contents of an e-book.

FIG. 5 is a flowchart illustrating a method of providing the play order and add-ons of an e-book according to an embodiment of the present invention.

FIG. 6 is a flowchart illustrating a method of providing the play order and add-ons of an e-book according to another embodiment of the present invention.

### BEST MODE

Hereinafter, a method of providing the play order and add-ons of an e-book will be described in detail with reference to exemplary embodiments of the present invention and the accompanying drawings. In order to clarify the present invention, a description irrelevant to the constitution of the present invention will be omitted, and in the drawings, like reference numerals refer to like elements throughout.

Since the terms “including”, “comprising”, and “having” can be construed as encompassing corresponding components unless specially described as opposite, it should be understood that they do not exclude other components but encompass other components. Unless defined otherwise, all technical and scientific terms have the same meanings as commonly understood by those skilled in the art to which the present invention belongs.

In the detailed description of the invention and claims, components named as “˜unit”, “˜part”, “˜module”, and “˜block” mean units that process at least one function or operation, and each of which can be implemented by software, hardware, or a combination thereof.

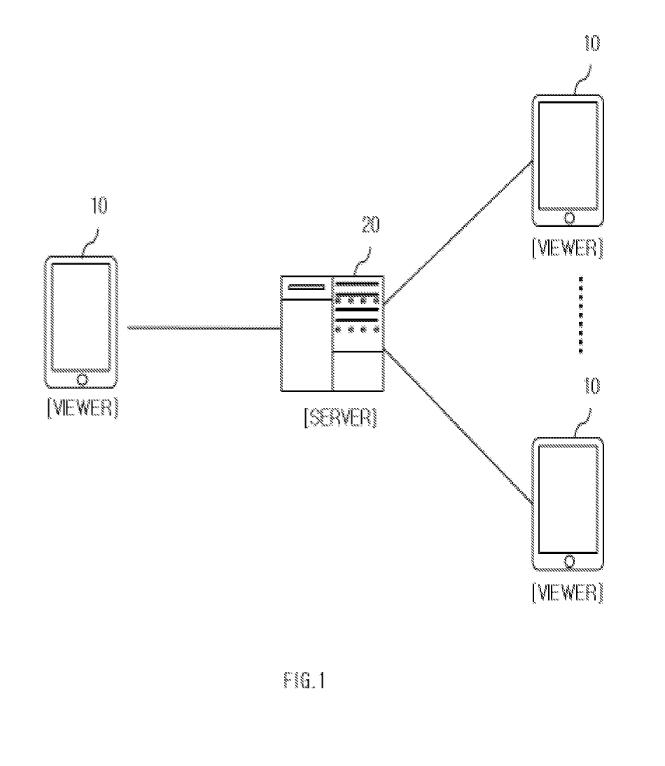

FIG. 1 is a view illustrating a relationship of a viewer, viewers of other users and a server.

A viewer 10, which is a unit for loading an e-book into volatile/non-volatile memories and displaying and playing the e-book, may include hardware resources such as smartphones or e-book readers, or may also be software which is executed on hardware such as personal computers and displays and plays an e-book on the screen.

Meanwhile, the term e-book may include well-known e-books, and may denote electronic types of books written according to a certain order like books of a classic concept. However, as long as satisfying the foregoing definition, the form thereof is not limited, and is not limited to a specific format of data commonly referred to as e-book by a well-known technology.

Meanwhile, the viewer 10 may load an e-book and display the e-book on the screen by the operation of a user. Furthermore, the viewer 10 may enable efficient reading and learning of an e-book using certain play order and add-ons as described later.

The present invention may be applied to a process in which a lecturer gives a lecture on/offline using an already-worked e-book as a teaching material and students learn using the viewer 10.

The lecturer may prepare auxiliary materials added to an e-book selected as a teaching material by himself/herself, and may upload the auxiliary materials to the server 20, distributing the auxiliary material to students. Also, the lecturer may synchronize the play order of an e-book with his/her lecture order, inducing students to keep up with the lecture through learning and review.

Furthermore, a lecturer may allow various existing learning tools to be displayed on a certain location of the selected e-book, allowing students to be more actively involved in the learning process and enabling smooth teaching.

As shown in FIG. 1, the method of providing the play order and the add-ons of an e-book according to an embodiment of the present invention may be executed in the viewer 10 connected to the server 20 and the viewers 10 of other users through a network.

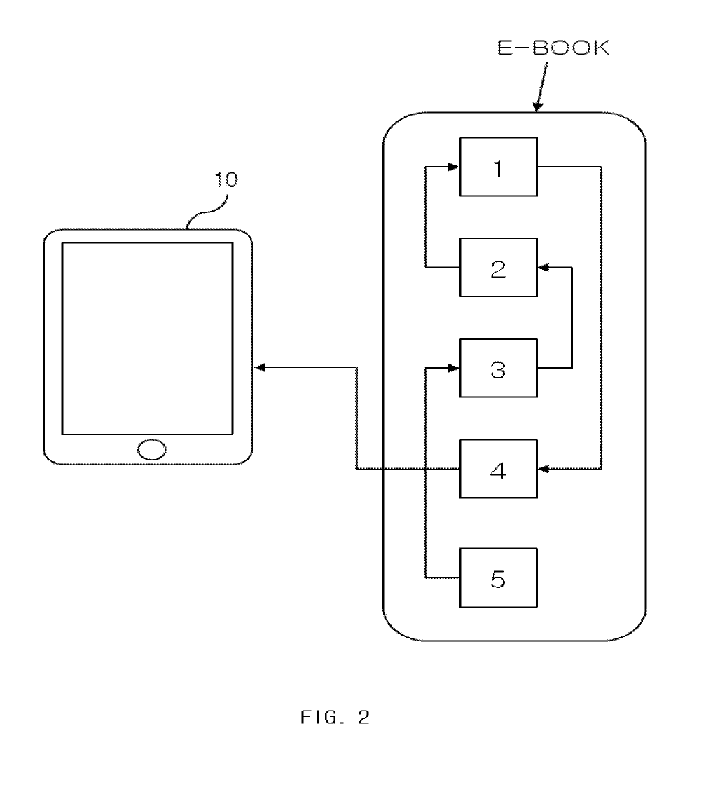

Hereinafter, a method of providing the play order and add-ons of an e-book will be described in detail with reference to FIGS. 2 to 5.

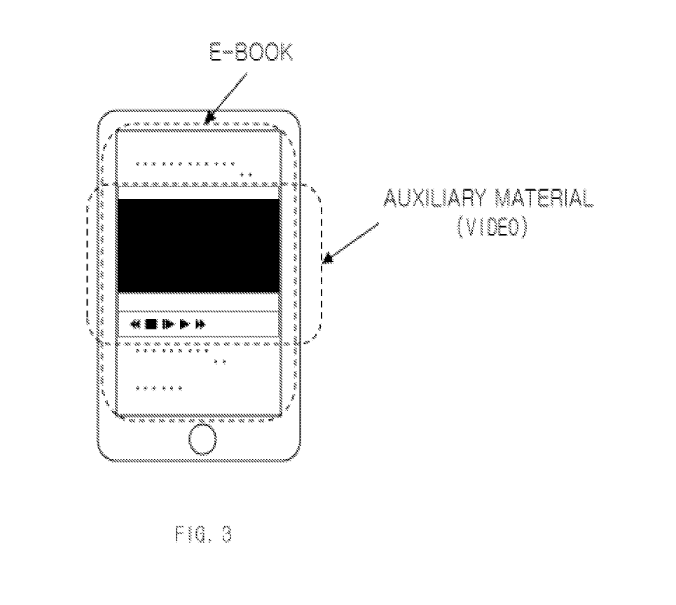

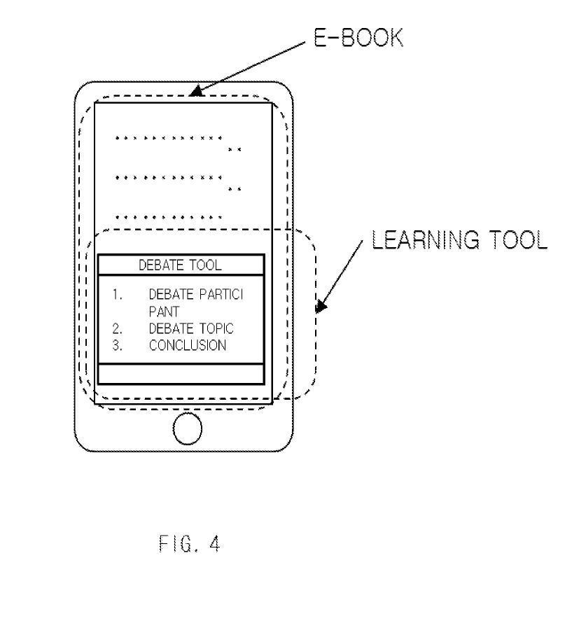

FIG. 2 is a view illustrating the play order of contents of an e-book reconfigured in real-time in accordance with the play order selected by a user. FIG. 3 is a view illustrating an auxiliary material related to contents of an e-book, being further displayed during the display of the contents of the e-book. FIG. 4 is a view illustrating a learning tool activated during the display of contents of an e-book.\

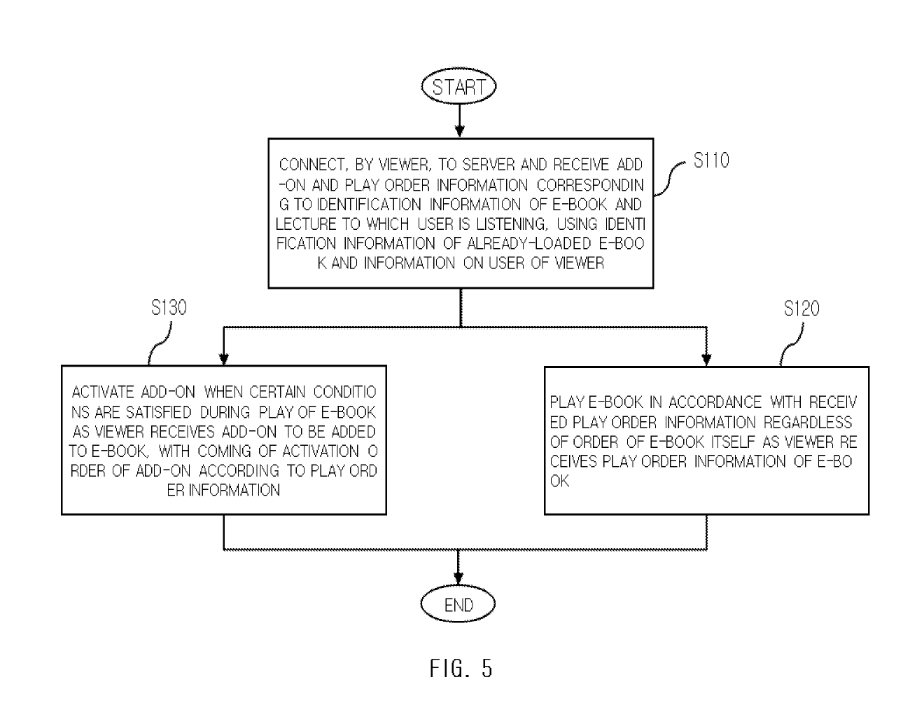

Meanwhile, FIG. 5 is a flowchart illustrating a method of providing the play order and add-ons of an e-book according to an embodiment of the present invention.

A user may operate the viewer 10 to load and then play an e-book. For example, a user may play e-book by turning pages by unit of page or automatically turning pages at a certain time interval by unit of page.

Meanwhile, as shown in the situation exemplified above, when a user listens to on/offline lectures using an e-book as a teaching material, a user may receive and install the play order and add-ons of an e-book prepared for the learning of the corresponding e-book through a network by operating the viewer 10, and may utilize the play order and add-ons of the e-book when a user plays the e-book.

For this, as shown in FIG. 5, the viewer 10 may be connected to the server 20 through a network according to the operation of a user.

Also, it may be verified whether or not information on the play order and add-ons corresponding to the identification information of the already-loaded e-book exist.

In this case, when the information on the play order and add-ons corresponding to the identification information of the e-book, the information on the play order and the add-ons may be provided from the server to be stored or loaded into a memory. However, add-ons and play order information corresponding to classes taken by a user may be selectively provided and loaded from add-ons and play order information corresponding to the identification information using user information of the viewer 10 (S110).

That is, when a plurality of lecturers selects the corresponding e-book, each lecturer may prepare appropriate play order information and auxiliary materials according to his/her own lecture style.

Accordingly, the viewer 10 may select and download the play order information and add-ons which are uploaded in advance to the server 20 by a lecturer of a lecture to which a user is listening.

For example, information corresponding to a user may be selectively provided by inquiring a user with a pre-inputted user ID or using information on student identification number, school and grade of a user.

In this case, the add-ons which are selectively provided for the viewer 10 may be external learning tools or auxiliary materials.

The external learning tool may mean a measure for checking the reading/learning situation of a viewer user when the user reads/learns by playing an e-book, or a measure for providing various functions relates to learning.

For example, the external learning tool may provide a communication measure for communication between a user of the viewer 10 and users of other viewers 10.

In a reading process using an e-book, the viewer 10 may display learning tools at one side of e-book contents as shown in FIG. 4 when the display order of specific external learning tools arrives.

In this case, when a displayed tool is a communication measure with users of other viewers 10, a user may input texts for communication with other users using the corresponding tool during the learning by an e-book.

For example, as described later, when the communication measure with users of viewers 10 is set to be activated at a location where a content “Please debate with other students” appears among contents of an e-book, with the coming of the corresponding time point during the play of the e-book, the viewer 10 may activate the corresponding learning tool and display the learning tool on one side of the screen as shown in FIG. 4.

Another example of external learning tools may include a measure for collecting the understanding degree of a user with respect to the e-book.

This is a function that has been implemented in a Learning Management System (LMS) by well-known technologies, and corresponds to a function of tracking the learning situation.

For example, the learning situation of a user may be tracked by collecting various types of information such as learning progress situation and quiz score degree.

As shown in FIG. 4, such a tool may also be displayed on one side of the screen with the coming of the set order during the play of an e-book.

Another example of external learning tools may include a measure for enabling exchange of certain data between a user of the viewer 10 and users of other viewers 10.

Assuming that a lecturer also uses the viewer 10, the lecturer may set a task to a user of the viewer 10 who is listening to his/her lecture.

For example, with the coming of a time point when one installment of a lecture ends up, such a learning tool may be called and displayed on the screen as shown in FIG. 4. Also, a lecturer may make the contents of a task into a file format such as text, and may deliver the file format in real-time to students who are users of the viewer 10.

On the other hand, students who are users of the viewer 10 may perform a task and then upload the product of the task through the foregoing learning tool. The product of the task may be directly delivered to the viewer 10 of a lecturer.

Another example of external learning tools may include a measure for enabling a user of the viewer 10 to perform learning through a certain interaction.

For example, a learning tool that provides a quiz at a portion where the contents of an e-book corresponding to the basic theory end up may be displayed on one side of the screen as shown in FIG. 4.

In this case, a user of the viewer 10 may solve a quiz provided through the learning tool, based on reading/learning to the contents of an e-book.

In a related art, a portion of such tools has already been provided by the LMS. For example, in the e-learning technical field, various functions such as a bulletin board function, a debate function, and task submit function are being called and used by the operation of a user upon play of web-based learning contents.

However, regardless of learning contents, these functions can be used only when a user calls the functions. On the other hand, in the present invention, the functions of the learning tools may be disposed in the right places of contents of e-books which are already being authored and distributed, enabling organic learning.

Meanwhile, the external learning tools may be provided by a separate server, and may be developed so as to be called and used in real-time by links of the corresponding tools. In the present invention, tools developed as above may be used in linkage with an e-book.

The functions provided by the external learning tools and the forms of the external learning tools will not be limited.

Meanwhile, the auxiliary materials may mean various kinds of materials provided for a user of the viewer 10 while a lecturer is giving a lecture using an e-book as a teaching material.

Examples of auxiliary materials may include lecture notes, various types of contents related to a lecture, printed material, and exercises.

For example, when a lecturer prepares a video in order to help the understanding on specific contents of an e-book, as shown in FIG. 3, the viewer 10 may display and play the corresponding video on one side of the screen at a location corresponding to the specific contents of the e-book when a user of the viewer 10 listening to a lecture of the lecturer plays the corresponding e-book.

That is, in addition to reading/learning through simple reading of an e-book by unit of page, a video related to a specific content may be displayed on the screen in its turn, thereby enabling smoother learning.

Meanwhile, in a typical e-learning technical field, lecture videos of lecturers and materials prepared by lecturers are collected to be provided for users.

However, when an object of learning is an e-book, it is difficult to provide various kinds of materials by organically linking the materials with the unit content of an e-book.

In the present invention, auxiliary materials that are various kinds of contents prepared by a lecturer in regard to an e-book, i.e., an object or target of learning may be organically combined with the unit contents to be displayed.

To this end, the viewer 10 may be provided with add-ons to be added to an e-book from the viewer 10 of a lecturer or from the server 20 through a network.

Also, the add-ons may be activated when certain conditions are satisfied during the play of the e-book (S120).

The add-ons may have an order to be displayed on the screen as shown in FIGS. 3 and 4 no matter whether the form of the add-on is an external learning tool or an auxiliary material.

In this case, the order means whether or not a portion of e-book is to be displayed on the screen as shown in FIGS. 3 and 4 when the portion of e-book is displayed.

That is, in operation S120, when the viewer 10 receives add-ons from the viewer 10 of another user (e.g., lecturer) or the server 20, the viewer 10 may be provided with information indicating which location of an e-book each add-on will be displayed on. Also, if a user plays the e-book using the viewer 10, the provided add-on may be activated eventually when the corresponding portion of the e-book is displayed.

That is, as described above, when the e-book is played up to a specific point, the learning tools for communication with users of other viewers 10 may be displayed as shown in FIG. 4. Alternatively, when the e-book is played up to a specific point, a video for helping understanding of the contents of the corresponding e-book may be displayed as shown in FIG. 3.

Through the foregoing process, the viewer 10 may allow the external learning tools or the auxiliary materials separately prepared from the e-book already-authored and distributed to be displayed on the screen when the specific point of the e-book is played.

Meanwhile, a lecturer may not perform a lecture according to the order of an e-book when the lecturer gives a lecture using an e-book as a teaching material.

In this case, a lecturer may generate separate play order information that defines the play order of an e-book.

Assuming the play unit of an e-book is a unit content, a lecturer may change the play order of each unit content or bundle of unit contents of the corresponding e-book using a separate authoring tool.

Naturally, the e-book itself is not reconfigured.

Thus, when a lecturer prepares the play order information of a specific e-book, the viewer 10 of a user may be provided with the play information of the e-book from the viewer 10 of the lecturer or the server 20.

In this case, the e-book may refer to one complete digital work that is authored and played in the order of pages to be displayed on the screen, but the viewer 10 may play the e-book in accordance with the provided play order information regardless of the order of pages as shown in FIG. 2 (S130).

As illustrated in FIG. 2, the e-book may have an order in which pages 1 to 5 are sequentially arranged, but the viewer 10 may first play the page 4, and then play the pages 1, 2, 3, and 5 regardless of the foregoing page order.

Meanwhile, as shown in FIG. 5, the display of add-on and the play process of an e-book according to the play order information by the viewer 10 may be separately performed regardless of the order. However, the learning tools or auxiliary materials as well as the unit contents of an e-book may be displayed in accordance with the order predetermined by the play order information.

That is, upon operation S130 after operation S120, the display order of the learning tools or the auxiliary materials may be determined by the play order information.

When the add-on is an external learning tool, in operation S130, the play order information may describe the play order of the unit content of the e-book and location information on the e-book, where the external learning tool is to be activated.

That is, the play order information further includes information on whether or not the external learning tool is to be displayed on the screen as shown in FIG. 4 when a certain portion of e-book is displayed.

The play order information may also include information on whether or not the activated external learning tool is to be inactivated when a certain portion of e-book is played.

Meanwhile, in operation S130, the viewer 10 may activate and display the external learning tool on the screen as shown in FIG. 4 eventually when the activation order of the external learning tool arrives during the play of the unit contents of the e-book according to the play order information.

Thus, when selecting an e-book by which it is not easy for a lecturer to interact with a reader and giving a lecture, the lecturer can maximize the teaching effect by inserting various kinds of tools for teaching students into specific locations of the e-book.

In this process, the e-book is not actually changed, and the learning tool is not actually inserted into the e-book. Such an effect may occur by the play order information.

Meanwhile, when the add-on is an auxiliary material, in operation S130, the play order information of the e-book may describe the play order of the unit contents of the e-book and the auxiliary materials.

That is, the play order information further includes information on which auxiliary material is to be displayed on the screen when a certain portion of e-book is displayed.

Thus, in operation S130, the viewer 10 may sequentially play the unit contents of the e-book and the auxiliary materials in accordance with the play order information when the e-book is played.

That is, the viewer 10 may not sequentially play only the unit contents of the e-book based on a certain play order, but may also play a specific unit content of the e-book and then display a specific auxiliary material as illustrate in FIG. 3. Thereafter, the viewer 10 may display the next order of the e-book on the screen thereof.

In this case, when the order of two or more auxiliary materials arrives at a specific play point, the play order information may also include information defining the order between the auxiliary materials.

That is, a video may be inserted and marked at a specific location of the e-book to help the understanding. Immediately thereafter, a printed material expatiating on the content of the video may be additionally marked, and then the next portion of the e-book may be played.

Thus, a lecturer can easily insert desired auxiliary materials in between the e-book in order to utilize the auxiliary material in his/her lecture while selecting an existing e-book, a change of which is not easy, as a teaching material.

Since the e-book is not changed, the copyright, particularly, the right to maintain the identity of the content can be retained.

Meanwhile, the play order information need not necessarily include all of locations where the whole play order, learning tool, or auxiliary material of the e-book are to be activated.

That is, although the viewer 10 plays the e-book according to the order of the e-book, the play order of the e-book may be changed through separate play order information in regard to only a portion that needs the change of the order.

Also, the play order information may exist in plurality with respect to one e-book.

For example, a lecturer may prepare new play order information for each subtopic, and may predetermine the learning order of an e-book and auxiliary materials.

If necessary, a user of the viewer 10 may read the e-book in the order of page, i.e., in the original order, but may select one from the play order of several subtopics displayed on one side of the screen and study while checking the e-book and the auxiliary materials in accordance with the lecture of a lecturer.

Thus, a user of the viewer 10 can learn while seeing the e-book and the auxiliary material which are rearranged in their order in accordance with the intention of a lecturer during the listening to online/offline lectures.

Accordingly, the interruption of learning which is caused by looking for the pages of an e-book or a printed material during the learning can be prevented.

Also, in case of solo review, since a user can read/learn while seeing the e-book and the auxiliary material in accordance with the order of online/offline lecture, a long-term memory effect by repetitive learning can be obtained.

Meanwhile, the viewer 10 is described to process the play order in case where add-ons are added to a single e-book in an embodiment of the present invention. However, in another embodiment of the present invention, the viewer 10 may load two or more e-books, and may perform the play process of a plurality of e-books in accordance with the play order information defining the play order between unit contents of the plurality of e-books.

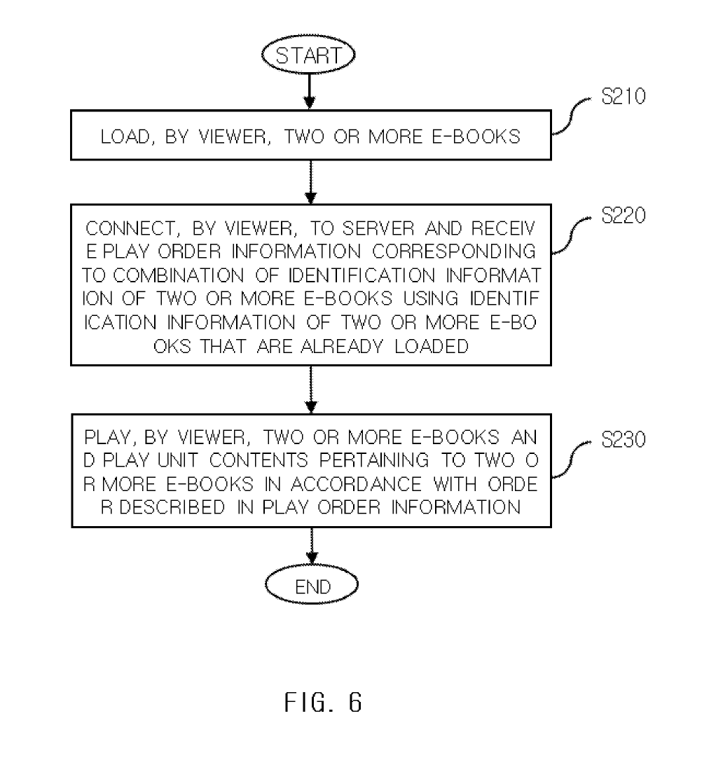

FIG. 6 is a flowchart illustrating a method of providing the play order and add-ons of an e-book according to another embodiment of the present invention.

This embodiment may correspond to a case where a lecturer gives a lecture by selecting two or more e-books as teaching materials.

As shown in FIG. 6, a viewer 10 may load two or more e-books in accordance with the operation of a user (S210).

For example, as a user may purchase or rent two or more e-books, the viewer 10 may download the two or more e-books or load a portion of the two or more e-books into a memory by a streaming method.

Thereafter, the viewer 10 may connect to a server 20 through a network according to the operation of a user, and may be provided with play order information corresponding to a combination of identification information of the two or more e-books using identification information of two or more e-books that are already loaded (S220).

For example, when a lecturer gives a lecture using two or more e-books as teaching materials, the lecturer may prepare play order information exchanged between unit contents of the two or more e-books, and may upload the play order information into the server 20.

Thus, the viewer 10 may connect to the server 20, and may receive the play order information corresponding to the combination of the two or more e-books instead of respective information of the two or more e-books.

That is, the play order information provided for the viewer 10 may define the order of unit contents exchanged between two or more e-books.

The viewer 10 may play the unit contents pertaining to two or more e-books according to the order described in the play order information received as above (S230).

That is, when a unit content of one of e-books is played and then the next order thereto is a specific unit content of another e-book, the corresponding content of the other e-book may be played and displayed.

In this case, when the unit contents pertaining to the two or more e-books are displayed, the unit contents may be displayed as if the unit contents pertain to one e-book, thereby smoothening the flow of reading/learning.

That is, when the order of unit contents pertaining to another e-book arrives while unit contents pertaining to one e-book are being displayed, the e-book that is first being played may not be closed and the other e-book may not be opened to display the corresponding unit contents. Instead, the e-book that is first being played may not be closed, and the unit contents pertaining to the other e-book may be displayed in succession to the unit contents that are finally played.

In another embodiment, the addition of the add-on and the control on the play order of the add-on may be performed identically to those of an embodiment. That is, other details described in an embodiment may also be identically applied to another embodiment except that the number of e-books increases to two or more.

Meanwhile, the methods of providing the play order and add-on of an e-book according to embodiments of the present invention can also be embodied as computer readable codes on a computer readable recording medium.

In this case, the computer readable recording medium is any data storage device that can store data which can be thereafter read by a computer system. Examples of the computer readable recording medium include DVD-read only memories (DVD-ROMs), CD-ROMs, hard disks, USB memories, and flash memories.

Meanwhile, the expression, ‘stored in a recording media’ does not compass only a case where contents are stored in recording media in mass quantity and distributed in a form of package, but also a case where contents are stored in recording media through a network in a form of data packet.

Although the term ‘server’ is used in this disclosure, the functions or loads are generally distributed and processed in a plurality of servers under a distributed computing environment. Thus, ‘server’ does not designate a single hardware component but may include a group of servers that are functionally categorized.

Although the term ‘network’ is used in this disclosure, the term should be construed as a broad concept compassing well-known wired/wireless communication methods such as Local Area Network (LAN) and Wide Area Network (WAN) depending on the distance and size, intranet and Virtual Private Network (VPN) depending on the characteristics of the connection route, and Wibro and WiFi depending on the connection method.

Meanwhile, although the term ‘e-book’ is used in this disclosure, the term refers to complete digital works having a certain order (preferably, page order), and is not necessarily limited to an e-book having a specific file format according to a related art.

In a related art, it is general that the whole data of an e-book is downloaded into the viewer 10 and is played by turning pages. However, in addition to the distribution of e-books by the download method, the present invention does not exclude a form in which only a portion of data such as table of contents is first downloaded and then pages to be played are provided in real-time from the server 20.

That is, these types of digital works should also be construed as pertaining to e-books referred to in the present invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of providing a play order and add-on of an e-book, which is executed in a viewer for playing an e-book that is a digital work described according to a certain order, the method comprising:
playing an e-book in accordance with a provided play order information regardless of the order of the e-book itself as the viewer is provided with the play order information.

2. The method of claim 1, further comprising activating the add-on when a certain condition is satisfied during the play of the e-book, as the viewer is provided with the add-on to be added to the e-book.

3. The method of claim 2, wherein the play order information of the e-book comprises a plurality of play orders re-defining a portion of unit contents of the e-book, and
in the playing of the e-book, the viewer sequentially displays the plurality of play orders on one side thereof, and as one of play orders is selected by a user, plays the portion of the unit contents of the e-book in accordance with the selected play order.

4. The method of claim 2, wherein:
the add-on is an external learning tool that collects information from the e-book or when the e-book is played by the viewer, and transmits/receives certain information to/from a server through a network;
the play order information describes the play order of the unit contents of the e-book and location information on the e-book, where the external learning tool is to be activated; and
in the playing of the e-book, the viewer activates the external learning tool when the activation order of the external learning tool arrives during the play of the unit contents of the e-book according to the play order information.

5. The method of claim 4, wherein the external learning tool provides:
a communication measure for communication between a user of the viewer and users of other viewers;
a measure for collecting an understanding degree of a user of the viewer with respect to the e-book;
a measure for enabling an exchange of certain data between a user of the viewer and users of other viewers; or
a measure for enabling a user of the viewer to perform learning through interaction.

6. The method of claim 2, wherein:
the add-on is an auxiliary material that is contents to be added to a certain location of the e-book;
the play order information of the e-book describes the play order of the unit contents of the e-book and the auxiliary materials; and
in the playing of the e-book, the viewer sequentially plays the unit contents of the e-book and the auxiliary materials in accordance with the play order information when the e-book is played.

7. The method of claim 6, wherein when the auxiliary material is a video,
in the playing of the e-book, the viewer plays and displays the video on one side of the unit contents of the e-book when the play order of the auxiliary material arrives in accordance with the play order information during the play of the e-book.

8. The method of claim 2, further comprising connecting, by the viewer, to a server and receiving data corresponding to a lecture to which a user is listening, as add-on and play order information corresponding to an identification information of the e-book using identification information of an already-loaded e-book and user information of the viewer.

9. A method of providing a play order and add-on of an e-book, which is executed in a viewer for playing an e-book that is a digital work described according to a certain order, the method comprising:
loading, by the viewer, two or more e-books;
connecting, by the viewer, to a server and receiving play order information corresponding to a combination of identification information of the two or more e-books using identification information of the two or more e-books that are already loaded; and
playing, by the viewer, unit contents pertaining to the two or more e-books according to an order described in the play order information,
wherein in the playing of the unit contents, when unit contents after a play of unit contents pertaining to one e-book are unit contents pertaining to another e-book, the viewer does not finish the play of the one e-book, and displays the unit contents of the other e-book in succession to unit contents that are finally played.
